(19) United States
(12) Patent Application Publication
(10) Pub. No.: US 2012/0191385 A1
(43) Pub. Date: Jul. 26, 2012

(54) METHOD FOR DETERMINING DETERIORATION OF FUEL CELL

(76) Inventors: Masaki Mitsui, Kyoto (JP); Takashi Akiyama, Osaka (JP)

(21) Appl. No.: 13/499,555

(22) PCT Filed: May 10, 2011
(86) PCT No.: PCT/JP2011/002594

§ 371 Date: Mar. 30, 2012

(30) Foreign Application Priority Data
Aug. 23, 2010 (JP) 2010-186329

(51) Int. Cl. G06F 19/00

(52) U.S. Cl. 702/60

(57) ABSTRACT

Deterioration of a fuel cell is accurately determined within a short period of time by the steps of: (a) detecting an output power P of a fuel cell; (b) detecting a peak of the output power P after a startup of the fuel cell; (c) calculating a decrease rate D of the output power P after the peak of the output power P; (d) comparing the calculated decrease rate D with a reference decrease rate Dref; and (e) determining deterioration of the fuel cell based on a comparison result of the step (d).

### TECHNICAL FIELD

This invention relates to fuel cell systems, and particularly to a technique for determining deterioration of fuel cells early.

### BACKGROUND ART

Recently, electronic devices have been rapidly becoming portable and cordless. Secondary batteries are usually used as the power source for driving such electronic devices. It is thus desired to develop small and light-weight secondary batteries with high energy density. Also, large secondary batteries for devices such as power storage devices and electric vehicles are required to provide long-term durability and safety, and techniques for large secondary batteries are also being developed actively.

However, when secondary batteries are used as the power source for driving portable and other devices, they need to be charged. While they are being charged, the devices powered thereby cannot be carried and used. As such, fuel cells, which are capable of supplying power to load devices continuously for a long time if only they are supplied with fuel, are receiving attention as the power source for driving portable and other devices.

Fuel cells have a cell stack comprising a stack of cells (unit cells); a fuel supply portion for supplying a fuel to the cell stack; and an oxidant supply portion for supplying an oxidant to the cell stack. Each cell is composed of a membrane electrode assembly in which an anode and a cathode are bonded to both sides of an electrolyte membrane so as to sandwich the electrolyte membrane. A plurality of membrane electrode assemblies are stacked with conductive separators therebetween, and an end plate is attached to each end in the stacking direction to form a cell stack. A fuel is supplied to the anode of each cell, while an oxidant is supplied to the cathode.

Among fuel cells, direct methanol fuel cells (DMFCs) are being developed actively. DMFCs use methanol, which is liquid at room temperature, as the fuel. Thus, compared with fuel cells using hydrogen or the like as the fuel, it is easy to reduce the size and weight of the fuel supply system. Therefore, by using a DMFC as the power source, it is possible to realize a portable device with good transportability. Also, since the fuel is liquid, the fuel can be easily carried, and it is possible to replenish the fuel while the user is out and use the load device continuously for a long time.

However, as the operation time of the fuel cell increases, the power generation performance deteriorates. Such deterioration of the fuel cell with time is caused by: enlarged catalyst particles (platinum particles) contained in the electrode; poisoned catalyst particles with carbon monoxide produced by oxidation reaction of methanol; decreased effective area of the catalyst particles due to attachment of impurities to the catalyst particles; etc. When the fuel cell deteriorates, the power generation capability decreases, so that sufficient power cannot be supplied to the load device. As a result, the load device may malfunction.

Therefore, when a fuel cell deteriorates, the deterioration of the fuel cell needs to be detected so that necessary measures such as replacement can be taken promptly.

In connection therewith, in PTL 1, a trouble of a fuel cell is detected by measuring the voltage of the fuel cell and comparing the measured voltage with a reference value. Therein, the reference value is corrected according to the total power generation time of the fuel cell, the number of startups and shutdowns, the power generation time elapsed from the startup of the fuel cell, etc.

### CITATION LIST

### Patent Literature

[PTL 1] Japanese Laid-Open Patent Publication No. 2008-97086

### SUMMARY OF INVENTION

### Technical Problem

Specifically, PTL 1 detects the occurrence of a trouble in the fuel cell based on the voltage of the fuel cell, and determines deterioration of the fuel cell with time in connection with the detection of the trouble. However, the output voltage of fuel cells changes due to various factors such as the temperature of the fuel cell, the state of oxidation of the catalyst, the temperature of the fuel and oxidant (e.g., air), etc. Therefore, the method of PTL 1 needs to control the temperature and the like of the fuel cell in order to accurately determine deterioration of the fuel cell with time.

However, in the case of small DMFCs, controlling the temperature of the fuel cells is substantially impossible. Therefore, the method of PTL 1 cannot accurately determine deterioration of fuel cells, in particular, DMFCs.

Further, fuel cells have such output power-time characteristics that the output voltage is relatively high immediately after the start of power generation, then lowers gradually, and reaches a steady state after the lapse of a predetermined time (e.g., 2 to 8 hours). As such, the method of PTL 1 cannot accurately determine deterioration before the output voltage reaches a steady state, and thus requires a long time from the startup of a fuel cell before detecting deterioration.

Further, in the actual operation of a fuel cell used in a portable device or the like, power generated by the fuel cell may be stored in a secondary battery to supply the stored power to a load device, in order to operate the load device stably. In this case, the fuel cell does not generate power continuously for a long time, but the fuel cell is operated in such a manner that the power generation is stopped after a relatively short period of time (e.g., 1 hour) and resumed. When the fuel cell is operated in such a manner, it is substantially impossible according to the method of PTL 1 to accurately determine deterioration of the fuel cell.

It is therefore an object of the invention to accurately determine deterioration of a fuel cell within a short period of time from the start of power generation without being affected by changes in such conditions as the temperature of the fuel cell and the oxidation state of the catalyst.

### Solution to Problem

This invention relates to a method for determining deterioration of a fuel cell, including the steps of:

(a) detecting an output power P of a fuel cell;

(b) detecting a peak of the output power P after a startup of the fuel cell;

(c) calculating a decrease rate D of the output power P after the peak of the output power P;

(d) comparing the decrease rate D with a reference decrease rate Dref; and

(e) determining deterioration of the fuel cell based on a comparison result of the step (d).

### Advantageous Effects of Invention

The invention enables accurate determination of deterioration of a fuel cell within a short period of time from the start of power generation of the fuel cell.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWING(S)

FIG. 1 is a functional block diagram of a fuel cell system to which the method for determining deterioration of a fuel cell in one embodiment of the invention is applied;

FIG. 2 is a partially enlarged sectional view schematically showing the structure of a fuel cell used in the fuel cell system;

FIG. 3 is a first flow chart for a process for determining deterioration;

FIG. 4 is a second flow chart for a process for determining deterioration;

FIG. 5 is a flow chart for a process for correcting temperature;

FIG. 6 is a graph showing an example of the output power-time characteristic curve of a fuel cell; and

FIG. 7 is a graph showing an example of the output power-cell temperature characteristic curve of the fuel cell.

### DESCRIPTION OF EMBODIMENTS

The method for determining deterioration of a fuel cell in one embodiment of the invention includes the steps of:

(a) detecting an output power P of a fuel cell;

(b) detecting a peak of the output power P after a startup of the fuel cell;

(c) calculating a decrease rate D of the output power P after the peak of the output power P;

(d) comparing the decrease rate D with a reference decrease rate Dref determined from an output power-time characteristic curve of the fuel cell that has not deteriorated; and

(e) determining deterioration of the fuel cell based on a comparison result of the step (d).

In fuel cells, after the start of power generation, the oxidation-reduction reaction in the fuel cells proceeds with time, and the output power (=Output voltage×output current) increases (see FIG. 6). The output power reaches a peak within a relatively short period of time (e.g., 2 to 8 minutes) and then decreases with time. The decrease rate decreases with time, and the output power becomes almost constant after the lapse of a predetermined time (e.g., 2 to 8 hours) from the start of power generation. The decrease rate as used herein is expressed with the decrease of the output power of the fuel cell being positive.

As noted above, the decrease rate of the output power after the peak of the output power of the fuel cell changes with time after the peak. The change in the decrease rate with time depends greatly on the deterioration of the fuel cell, irrespective of other conditions such as the temperature of the fuel cell. That is, if the degree of deterioration of the fuel cell is the same, even if other conditions (e.g., the temperature of the fuel cell) are different, the output power-time characteristic curve merely shifts in parallel, and the slope thereof remains almost unchanged.

On the other hand, if the degree of deterioration of the fuel cell is different, the slope of the output power-time characteristic curve changes. Therefore, by determining deterioration of the fuel cell based on the decrease rate, it becomes possible to accurately determine deterioration of the fuel cell irrespective of other conditions.

Further, deterioration is determined based on the decrease rate of the output power, not by comparing the output power in the steady state with a reference value. Thus, once the output power has reached a peak, deterioration of the fuel cell can be determined basically at any time. Therefore, when the fuel cell has deteriorated, the deterioration can be detected within a short period of time (e.g., within 5 minutes at fastest) after the startup of the fuel cell, although it depends on the degree of deterioration. Thus, compared with determination of deterioration of the fuel cell based on the output power in the steady state (e.g., 2 to 8 hours), it becomes possible to detect deterioration of the fuel cell within a very short period of time.

The method for determining deterioration of a fuel cell of a fuel cell system in another embodiment of the invention further includes the step (f) of comparing an output power Ppk at the peak with a first reference value Prf1. A determination that the fuel cell has deteriorated is made when the peak output power Ppk is smaller than the first reference value Prf1 and the decrease rate D is greater than the reference decrease rate Dref. Even when the peak output power Ppk is smaller than the first reference value Prf1, if the decrease rate D is equal to or less than the reference decrease rate Dref, a determination that the fuel cell has deteriorated is not made at once.

As described above, the determination of deterioration based on the decrease rate D and the peak output power enables more accurate determination of deterioration. This is because even when the peak output power is somewhat small, if the decrease rate is small, the output power in the steady state may become large enough to drive a load device.

On the other hand, when the peak output power is small and the decrease rate D is large, the output power in the steady state naturally becomes small. In this case, a determination that the fuel cell has deteriorated is made at once. In this case, since deterioration can be detected immediately after the peak of the output power, deterioration of the fuel cell can be detected within a very short period of time after the start of power generation. It is thus possible to take necessary steps such as replacement of the fuel cell at a very early stage.

The first reference value Prf1 is preferably set to a value smaller than the peak output power Prfp of the fuel cell that has not deteriorated by a predetermined rate α.

The first reference value Prf1 is a value to be compared with the peak output power Ppk to determine deterioration of the fuel cell, and it is appropriate to set the first reference value Prf1 relative to the peak output power Prfp of the deterioration-free fuel cell.

The predetermined rate a can be set to, for example, 10 to 30%. The reason why α is set to 10% or more is that in many devices, it is believed that the capacity of the fuel cell mounted therein is set so that sufficient power can be supplied to the load even if the power generating capability lowers to about 90% of the deterioration-free fuel cell.

Also, the reason why α is set to 30% or less is that in many devices, it is believed that if the power generating capability of the fuel cell lowers to about 70% of that without deterioration, sufficient power cannot be supplied to the load.

The method for determining deterioration of a fuel cell in still another embodiment of the invention further includes the step (g) of after the peak of the output power P, comparing the output power P with a second reference value Prf2 determined from the output power-time characteristic curve of the fuel cell that has not deteriorated, where Prf2<Prf1. A determination that the fuel cell has deteriorated is made when the peak output power Ppk is equal to or greater than the first reference value Prf1, the decrease rate D is greater than the reference decrease rate Dref, and the output power P is smaller than the second reference value Prf2.

As described above, even when the peak output power Ppk is equal to or greater than the first reference value Prf1, if the decrease rate D is greater than the reference decrease rate Dref, the monitoring of the output power is continued. When the output power becomes smaller than the second reference value Prf2 (Prf2<Prf1) determined from the output power-time characteristic curve, a determination that the fuel cell has deteriorated is made. The second reference value Prf2 is determined from the output power-time characteristic curve of the deterioration-free fuel cell. Thus, the second reference value Prf2 is a reference value that changes with time. That is, since the output power of the fuel cell changes with time until it reaches a steady state, the second reference value Prf2 changes in proportion to the amount of change in the output power.

The reason why the second reference value Prf2 is set to a reference value that changes with time is that the output power of the fuel cell gradually decreases after the peak, as noted above. Contrary to this, when a fixed reference value is used to determine deterioration, the reference value needs to be a reference value to be compared with the output power in the steady state.

That is, in this embodiment in which the reference value (Prf2) determined from the output power-time characteristic curve is used to determine deterioration of the fuel cell, the curve described by the reference value is also highest at the point of time corresponding to Prfp and then gradually lowers. Thus, if the fuel cell has deteriorated, the deterioration can be detected without having to wait for the output power P to reach a steady state. As a result, it becomes possible to detect deterioration earlier (e.g., within 30 minutes, at latest, after the start of power generation) than to determine deterioration using a fixed reference value.

The second reference value Prf2 is preferably set to a value smaller than the output power Ppoc on the output power-time characteristic curve of the deterioration-free fuel cell at a corresponding point of time by the predetermined rate α due to the same reason as described above.

The method for determining deterioration of a fuel cell in still another embodiment of the invention further includes the step (h) of after the peak of the output power P, comparing the output power P with a third reference value Ppk0 where Ppk0<Prf2. A determination that the fuel cell has deteriorated is made when the peak output power Ppk is smaller than the first reference value Prf1, the decrease rate D is equal to or less than the reference decrease rate Dref, and the output power P is smaller than the third reference value Ppk0.

As mentioned above, even when the peak output power Ppk is smaller than the first reference value Prf1, if the decrease rate D is equal to or less than the reference decrease rate Dref, a determination that the fuel cell has deteriorated should not be made at once. In this case, the monitoring of the output power is continued, and only when the output power becomes smaller than the third reference value Ppk0, a determination that the fuel cell has deteriorated is made. This makes it possible to prevent a determination that the fuel cell has deteriorated from being made when the fuel cell has a minimum power generating capability sufficient for charging, for example, a storage battery attached to the fuel cell. Therefore, deterioration can be determined promptly while ensuring accuracy.

In the method for determining deterioration of a fuel cell in still another embodiment of the invention, the detected value of output power or the reference value is corrected according to the temperature of the fuel cell.

As noted above, the output power of the fuel cell depends on the temperature of the fuel cell, and the output power-time characteristic curve shifts upward and downward according to the temperature of the fuel cell. Therefore, in an environment in which the temperature of the fuel cell is subject to change, when the peak output power Ppk is compared with the first reference value Prf1, or when the output power after the peak is compared with the second reference value Prf2, it is preferable to make a temperature correction. This enables more accurate determination of deterioration. In this case, it is possible to correct the detected value of output power P according to the temperature, or correct the reference values (Prf1, Prf2) according to the temperature. It is also possible to correct both the output power and the reference values.

Embodiments of the invention are described with reference to drawings.

### Embodiment 1

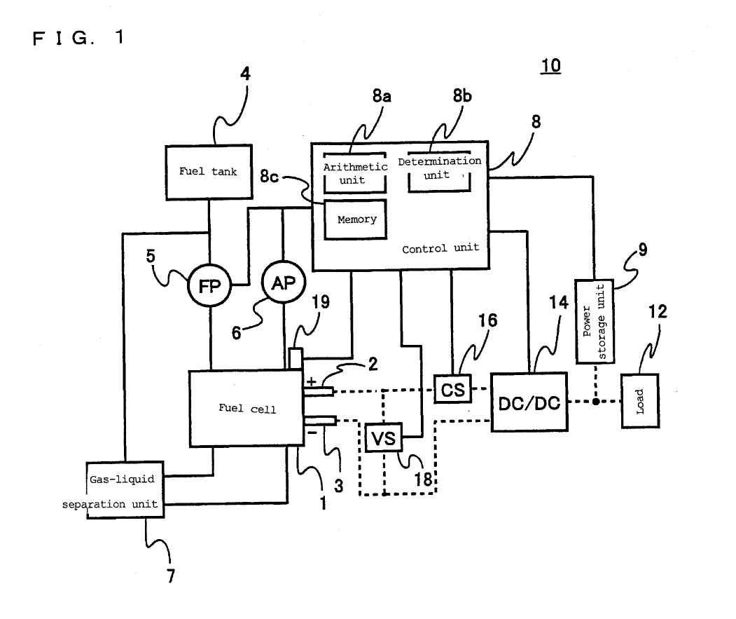

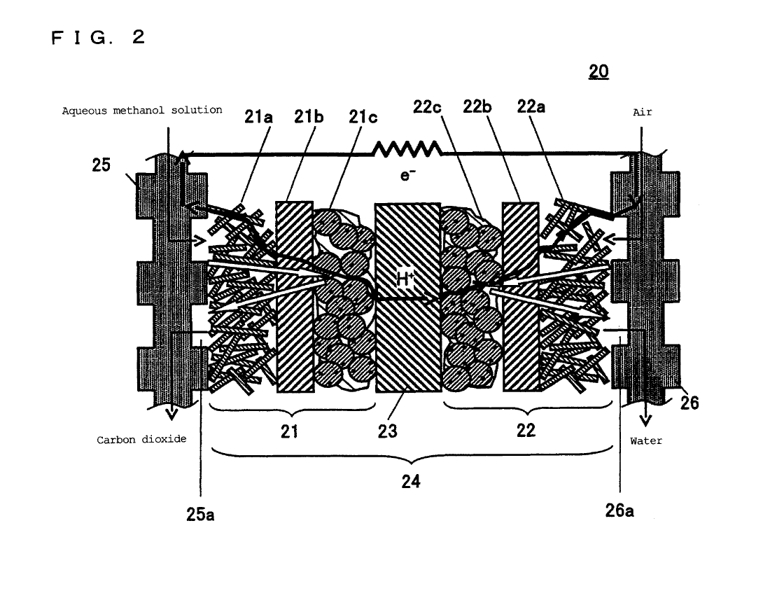

FIG. 1 is a functional block diagram of a fuel cell system to which the method for determining deterioration of a fuel cell in one embodiment of the invention is applied. FIG. 2 is a partially enlarged sectional view schematically showing the structure of a fuel cell used in the fuel cell system.

A fuel cell system 10 illustrated in FIG. 1 includes: a fuel cell 1; a fuel tank 4 for storing a fuel (in the case of the apparatus illustrated therein, methanol); a fuel pump (FP) 5 for supplying a mixture (aqueous methanol solution) of water and the fuel stored in the fuel tank 4; an air pump (AP) 6 for supplying an oxidant (in the illustrated example, air) to the fuel cell 1; and a gas-liquid separation unit 7 for separating unreacted fuel and water from the effluent from the fuel cell 1 and returning them to the fuel pump 5. The fuel cell 1 has a positive terminal 2 and a negative terminal 3.

The fuel cell system further includes: a control unit 8 equipped with an arithmetic unit 8a, a determination unit 8b, and memory 8c; a power storage unit 9 for storing power generated by the fuel cell 1; a DC/DC converter 14 for converting the voltage of the output of the fuel cell 1 and transmitting it to the power storage unit 9 and a load 12; a current sensor (CS) 16 for detecting the output current of the fuel cell 1; a voltage sensor (VS) 18 for detecting the output voltage of the fuel cell 1; and a temperature sensor 19 for detecting the temperature of the fuel cell 1. The signals detected by the current sensor 16, the voltage sensor 18, and the temperature sensor 19 are input into the control unit 8.

The current sensor 16 is connected between the positive terminal 2 and the DC/DC converter 14 so that the current sensor 16 and the DC/DC converter 14 are in series. The voltage sensor 18 is connected between the positive terminal 2 and the negative terminal 3 so that the voltage sensor 18 and the DC/DC converter 14 are in parallel. The temperature sensor 19 can be installed at a suitable position of the fuel cell 1. The temperature sensor 19 is desirably a thermistor.

The control unit 8 controls the DC/DC converter 14 to adjust the voltage supplied to the load 12 and control the charge/discharge of the power storage unit 9. Also, the control unit 8 controls the fuel pump 5 and the air pump 6 to control the amounts of fuel and oxidant supplied to the fuel cell 1. The control unit 8 can be composed of a CPU (Central Processing Unit), a micro computer, an MPU (Micro Processing Unit: micro processor), main memory, auxiliary memory, etc.

The memory 8c of the control unit 8 is an auxiliary storage device (nonvolatile memory), and stores the output power-time characteristic table of the fuel cell and the output power-cell temperature characteristic table of the fuel cell which are described below.

The control method of the DC/DC converter 14 is preferably the PWM (Pulse Width Modulation) control method in which the output voltage is adjusted by modulating the pulse width (duty ratio) while keeping the switching pulse frequency constant, because it can reduce the ripple voltage and provide a quick response.

Referring now to FIG. 2, the fuel cell is described. The fuel cell 1 includes at least one cell (unit cell). FIG. 2 illustrates the structure of a cell.

A cell 20 has a membrane electrode assembly (MEA) 24 where power is generated. It should be noted that a fuel cell is typically composed of a plurality of stacked MEAS 24 and that the MEAS 24 are stacked with separators 25 and 26 interposed therebetween. Both ends of the stack of the MEAS 24 (cell stack) in the stacking direction are fitted with an anode-side end plate and a cathode-side end plate, not shown, respectively.

Each MEA 24 includes an anode (electrode) 21, a cathode (electrode) 22, and an electrolyte membrane 23 interposed between the anode 21 and the cathode 22.

The anode 21 includes an anode diffusion layer 21a, an anode microporous layer (MPL) 21b, and an anode catalyst layer 21c. The anode catalyst layer 21c is laminated on the electrolyte membrane 23, the anode MPL 21b is laminated thereon, and the anode diffusion layer 21a is laminated thereon. The separator 25 is in contact with the anode diffusion layer 21a.

Likewise, the cathode 22 includes a cathode diffusion layer 22a, a cathode microporous layer (MPL) 22b, and a cathode catalyst layer 22c. The cathode catalyst layer 22c is laminated on the electrolyte membrane 23, the cathode MPL 22b is laminated thereon, and the cathode diffusion layer 22a is laminated thereon. The separator 26 is in contact with the cathode diffusion layer 22a.

The anode diffusion layer 21a and the cathode diffusion layer 22a can be formed of carbon paper, carbon felt, carbon cloth, etc. The anode MPL 21b and the cathode MPL 22b can be composed of polytetrafluoroethylene or tetrafluoroethylene-hexafluoropropylene copolymer, and carbon.

The anode catalyst layer 21c and the cathode catalyst layer 22c include a catalyst suitable for the electrode reaction, such as platinum or ruthenium. The catalyst is supported on a carbonaceous material by pulverizing the catalyst and highly dispersing the resulting fine particles on the surface of the carbonaceous material. The carbon with the catalyst supported thereon is bound by a binder to form the anode catalyst layer 21c and the cathode catalyst layer 22c.

The electrolyte membrane 23 can be an ion-exchange membrane which allows hydrogen ions to pass through, and can be composed of, for example, a perfluorosulfonic acid-tetrafluoroethylene copolymer.

The separators 25 and 26 can be formed of a conductive material such as a carbon material. The face of the separator 25 in contact with the anode 21 is provided with a fuel flow channel 25a for supplying a fuel to the anode 21. The face of the separator 26 in contact with the cathode 22 is provided with an oxidant flow channel 26a for supplying an oxidant to the cathode 22. Each of the flow channels 25a and 26a can be formed, for example, by forming a groove in the above-mentioned face.

An aqueous solution containing methanol as the fuel is supplied to the anode 21, while air containing oxygen as the oxidant is supplied to the cathode 22. The methanol and steam derived from the aqueous methanol solution supplied to the anode 21 are diffused throughout the anode microporous layer 21b by the anode diffusion layer 21a. Further, they pass through the anode microporous layer 21b and reach the anode catalyst layer 21c. Likewise, the oxygen contained in the air supplied to the cathode 22 is diffused throughout the cathode microporous layer 22b by the cathode diffusion layer 22a. Further, it passes through the cathode microporous layer 22b and reaches the cathode catalyst layer 22c.

Also, in fuel cells, it is common to use oxygen in the air as the oxidant. This oxidant is also supplied to the cathode 22 of each cell according the amount of power generation.

The reactions at the anode and cathode of a DMFC are shown by the following reaction formulae (1) and (2), respectively.

Anode: CH₃OH+H₂O→CO₂+6H⁺+6e (1)

Cathode: (3/2)O₂+6H⁺+6e⁻3H₂O (2)

As shown by the above reaction formulae (1) and (2), carbon dioxide as a reaction product and an aqueous solution of unreacted methanol as the remaining fuel are discharged from the anode 21, while water (steam) as a reaction product and nitrogen and unreacted oxygen in the air are discharged from the cathode 22.

Of the fuel supplied to the anode 21, surplus fuel is transported as an aqueous methanol solution to the fuel pump 5 from the gas-liquid separation unit 7 without being consumed in the fuel cell 1. Carbon dioxide generated at the anode 21 is also transported to the gas-liquid separation unit 7, separated from the aqueous methanol solution in the gas-liquid separation unit 7, and discharged to outside.

Meanwhile, the air containing oxygen as the oxidant is pressurized by the oxidant pump 6, and transported to the cathode 22. At the cathode 22, water is produced (see the above reaction formula (2)). Of the air supplied to the fuel cell 1, surplus air is mixed with the produced water, and transported as a gas-liquid mixture to the gas-liquid separation unit 7. The air transported to the gas-liquid separation unit 7 is separated from the water, and discharged to outside.

As described above, the concentration of the aqueous methanol solution as the fuel can be adjusted by circulating the liquid components such as the water discharged from the fuel cell 1 by using the gas-liquid separation unit 7. As a result, it is possible to realize a system which does not need to be supplied with water from outside. It is also possible to realize a system which does not need to discard water as the reaction product to outside. It is thus possible to realize a maintenance-free system which requires no maintenance over a long period of time. It is therefore possible to further improve the transportability and portability of the fuel cell system.

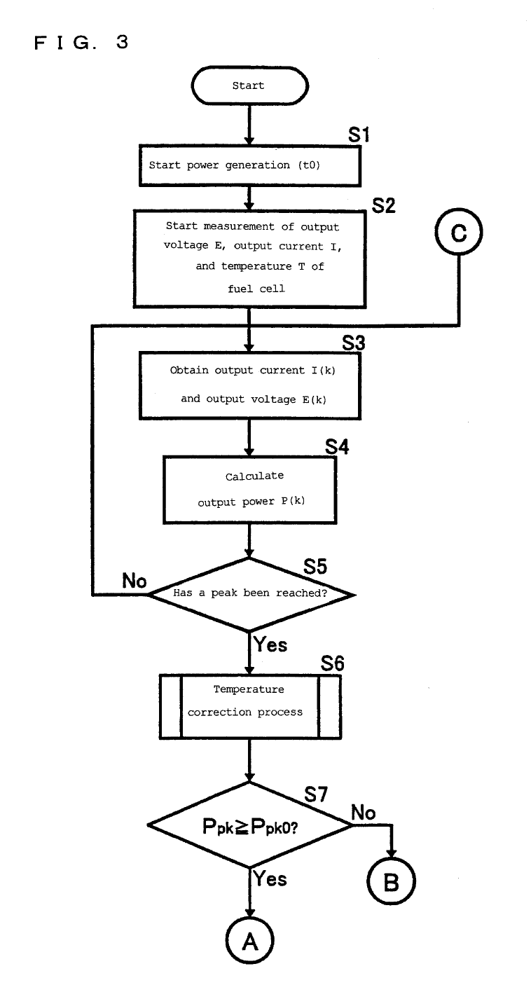

Referring now to FIG. 3 to FIG. 7, the operation of the fuel cell system controlled by the control unit is described.

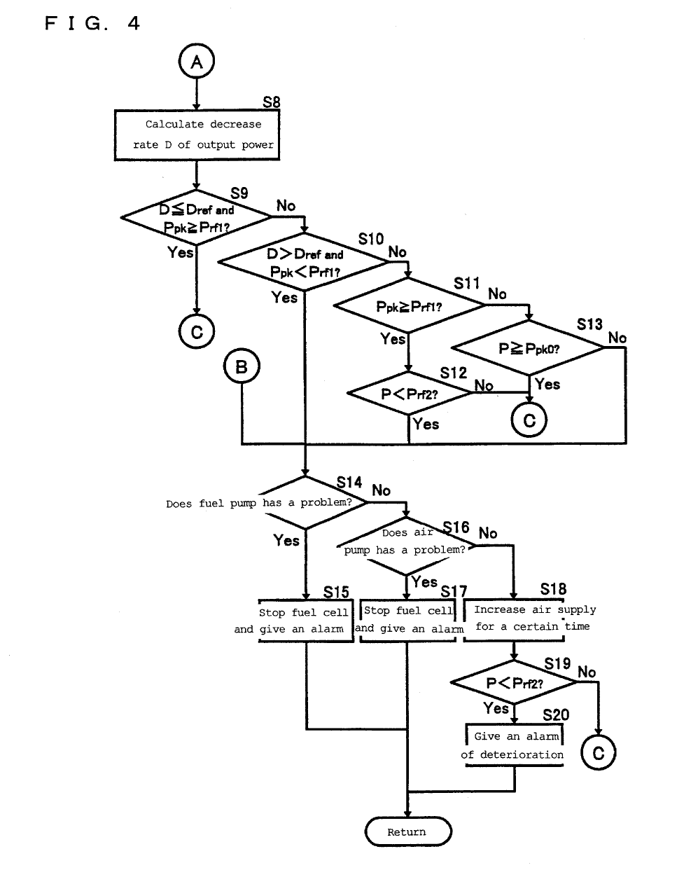

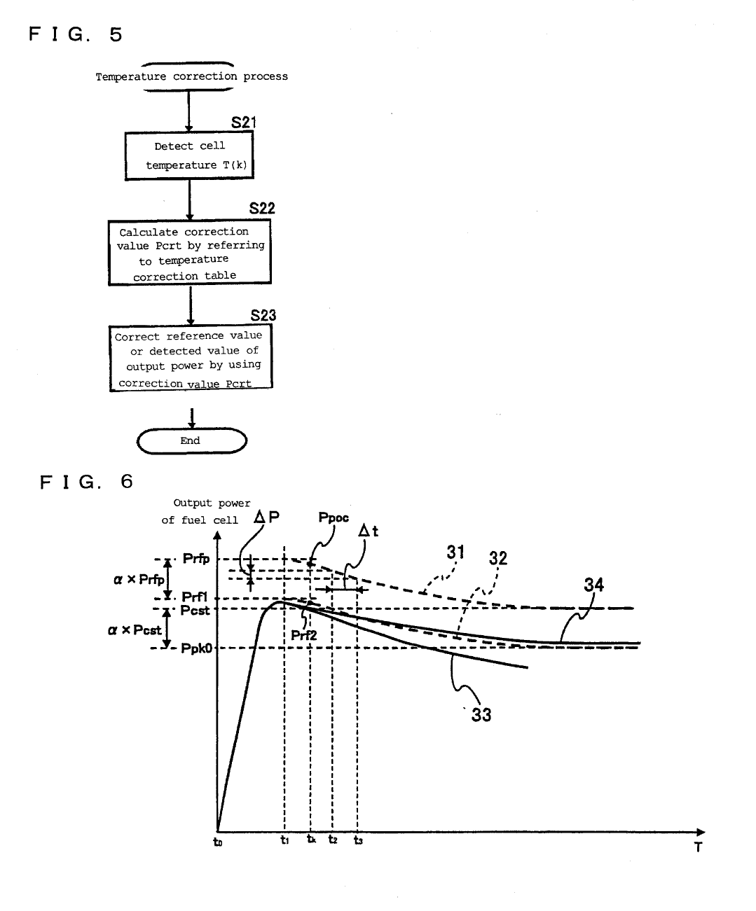

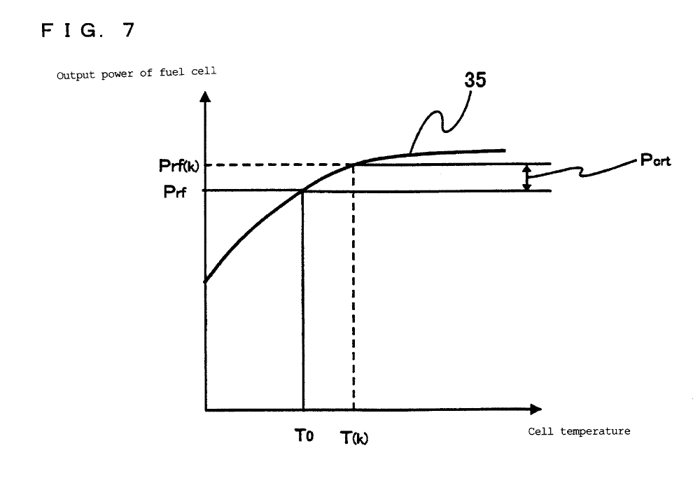

FIG. 3 and FIG. 4 are flow charts for the deterioration determination process performed by the control unit 8. FIG. 5 is a flow chart for the temperature correction process. FIG. 6 is a graph showing an example of the output power-time characteristic curve. FIG. 7 is a graph showing an example of the output power-cell temperature characteristic curve.

When the power generation of the fuel cell is started at time t0 (step S1), the measurements of the output current I, output voltage E, and temperature T (hereinafter referred to as cell temperature) of the fuel cell are started (step S2). For example, the output current I(k) (k=1, 2, . . . , n, . . . ) and output voltage E(k) of the fuel cell are input into the arithmetic unit 8a every second (step S3), and the input current value I(k) and the input voltage value E(k) are multiplied together to calculate the output power P(k) of the fuel cell (step S4). Also, in parallel with step S2, various data such as the output power-time characteristic table and the output power-cell temperature characteristic table are input into the arithmetic unit 8a from the memory 8c.

The output current I(k) and output voltage E(k) of the fuel cell may be average values to reduce the impact of small variation of these values. For example, the measured values of the output current I and the output voltage E are input into the arithmetic unit 8a every 20 milliseconds, and the latest input data (e.g., five values) are averaged (moving average process), and the resulting average values may be used as the current value I(k) and the voltage value E(k).

Next, the latest detected value P(n) (n is an integer of 2 or more) of the output power P(k) is compared with the previous detected value P(n−1) to determine whether the output power P of the fuel cell 1 has reached a peak (step S5). For example, if the latest detected value P(n) of output power is equal to or less than the previous detected value P(n−1), a determination that the output power of the fuel cell has reached a peak is made. If the latest detected value P(n) is larger than the previous detected value P(n−1), a determination that the output power of the fuel cell has not reached a peak is made.

If the output power P of the fuel cell 1 has reached a peak (“Yes” in step S5), the process proceeds to a temperature correction process (step S6) to avoid making an inaccurate determination of deterioration due to the dependence of the output power of the fuel cell 1 to temperature. The temperature correction process will be described below.

If the output power P of the fuel cell 1 has not reached a peak (“No” in step S5), the process returns to step S3. Steps S3 to S5 are repeated until the latest detected value P(n) becomes equal to or less than the previous detected value P(n−1), i.e., until the output power of the fuel cell reaches a peak. At this time, the peak power Ppk of the fuel cell is defined as the value of power P(n−1) at which a determination that the output power P of the fuel cell 1 has reached a peak is made. It should be noted that step S5 can be skipped once a determination that the output power P has reached a peak is made.

Upon completion of the temperature correction process of step S6, whether the peak power Ppk is equal to or greater than the reference value Ppk0 for determining serious deterioration is determined (step S7). The reference value Ppk0 for determining serious deterioration is determined based on the output power-time characteristic table of the deterioration-free fuel cell 1 retrieved from the memory 8c. It should be noted that step S7 can also be skipped once a determination that the peak power Ppk is equal to or greater than the reference value Ppk0 is made.

An example of output power-time characteristic table is shown in FIG. 6 by an output power-time characteristic curve (curve 31) equivalent to the table. The output power-time characteristic curve shows a change with time in the output power of a deterioration-free fuel cell in the initial state which was operated to generate power with the amount of fuel supply and the cell temperature set to predetermined values. It should be noted that the curve 31 shows a change with time in output power after the output power of the fuel cell 1 that started power generation at time t0 reached a peak at time t1.

The set value for the amount of fuel supply used for the curve 31 is the stoichiometric amount of fuel for providing desired output power. The set value for the cell temperature used for the curve 31 is the temperature at which the amount of water produced by the reaction of the fuel cell and remaining in the system is equal to the amount of water used for diluting fuel. This temperature is hereinafter referred to as reference temperature T0.

The reference value Ppk0 for determining serious deterioration is set to a value smaller than the output power Pcst corresponding to the flat portion of the curve 31, that is, the output power in the steady state of the deterioration-free fuel cell 1 in the initial state by a predetermined rate α (e.g., 10 to 30%).

As such, the reference value Ppk0 for determining serious deterioration is the minimum power the fuel cell 1 is required to generate. For example, it is equal to the average amount of power consumed by the load 12. Thus, if the peak power Ppk is smaller than the reference value Ppk0, sufficient power cannot be supplied to the load 12, and the power storage unit 9 is discharged only. Ultimately, the fuel cell system 10 cannot be started up. Therefore, if the peak power Ppk is smaller than the reference value Ppk0 (“No” in step S7), the process immediately proceeds to step S14 and subsequent steps on the assumption that the fuel cell 1 may have deteriorated.

If the peak power Ppk is equal to or greater than the reference value Ppk0 (“Yes” in step S7), the decrease rate D of the output power P of the fuel cell 1 is calculated (step S8). The decrease rate D can be determined by subtracting the latest detected value P(n) of output power (e.g., time t2) from the next detected value P(n+1) of output power (e.g., time t3) to obtain a difference (LP) and converting the difference to a value per unit time. That is, D=ΔP/Δt (Δt=t3−t2). The times t2 and t3 can be any given times after the output power P of the fuel cell 1 has reached a peak.

Next, whether the decrease rate D is equal to or less than the reference decrease rate Dref and the peak power Ppk is equal to or greater than the first reference value Prf1 for determining mild deterioration is determined (step S9). The reference value Prf1 for determining mild deterioration is set to a value smaller than the peak power Prfp of the output power-time characteristic curve (curve 31) of the deterioration-free fuel cell 1 by the above-mentioned predetermined rate β.

If the result of step S9 is affirmative (“Yes”), the process returns to step S3 on the assumption that the fuel cell 1 has not deteriorated.

If the result of step S9 is negative (“No”), whether the decrease rate D is greater than the reference decrease rate Dref and the peak power Ppk is smaller than the first reference value Prf1 is determined (step S10).

If the result of step S10 is affirmative (“Yes”), the output power in the steady state is also assumed to be smaller than the reference value Ppk0 for determining serious deterioration (see curve 33). Thus, in this case, the process proceeds to step S14 and subsequent steps on the assumption that there may be deterioration.

If the result of step S10 is negative (“No”), whether the peak power Ppk is equal to or greater than the reference value Prf1 is determined (step S11). If the peak power Ppk is equal to or greater than the reference value Prf1 (“Yes” in step S11), the decrease rate D is greater than the reference decrease rate Dref. That is, Ppk≧Prf1 and D>Dref. In this case, the output power P is further compared with the second reference value Prf2 that changes with time (step S12).

The second reference value Prf2 is set to a value smaller than the output power Ppoc on the output power-time characteristic curve (curve 31) at a time (=tk−t1) elapsed after the output power P of the fuel cell 1 has reached the peak by the above-mentioned predetermined rate α. That is, the reference value Prf2 is a value of power on a curve 32, which is drawn by shifting the curve 31 downward in parallel by α×Prfp(V), at a time elapsed after the output power P of the fuel cell 1 has reached the peak.

When the output power P is equal to or greater than the reference value Prf2 (“No” in step S12), the process returns to step S3 on the assumption that no deterioration has been detected at that time. Thereafter, as long as the output power P is equal to or greater than the reference value Prf2, step S3 and subsequent steps are repeated on the assumption that no deterioration has been detected. If the output power P is smaller than the reference value Prf2 (“Yes” in step S12), the process proceeds to step S14 and subsequent steps on the assumption that there may be deterioration.

As described above, when Ppk≧Prf1 and D>Dref, the output power P is compared with the reference value Prf2 that changes with time to determine deterioration of the fuel cell 1. In this case, when the fuel cell 1 has deteriorated, the deterioration is detected early, and thus, necessary measures can be taken immediately.

In step S11, if the peak power Ppk is smaller than the reference value Prf1 (“No” in step S11), the decrease rate D is equal to or less than the reference decrease rate Dref. That is, Ppk<Prf1 and D≦Dref. In this case, the output power P in the steady state may be greater than the reference value Ppk0 for determining serious deterioration, as shown by a curve 34. Thus, whether the output power P is equal to or greater than the reference value Ppk0 for determining serious deterioration is determined (step S13).

When the output power P is equal to or greater than the reference value Ppk0 for determining serious deterioration (“Yes” in step S13), the process returns to step S3 on the assumption that no deterioration has been detected at that time. Thereafter, as long as the output power P is equal to or greater than the reference value Ppk0, step S3 and subsequent steps are repeated on the assumption that no deterioration has been detected. If the output power P is smaller than the reference value Ppk0 (“No” in step S13), the process proceeds to step S14 and subsequent steps on the assumption that there may be deterioration.

As described above, when Ppk<Prf1 and D≦Dref, the output power P is compared with the reference value Ppk0 for determining serious deterioration to determine deterioration of the fuel cell 1, and this makes it possible to prevent a determination that the fuel cell 1 has deteriorated from being made when the fuel cell 1 has a minimum power generating capability.

Next, in step S14, whether the fuel pump 5 has a problem is determined to determine whether the decrease in the output of the fuel cell 1 is caused by a shortage of the fuel supplied.

Examples of problems associated with the fuel pump 5 include failure of the motor for driving the pump and clogging of the pump with foreign matter. To detect such a problem, for example, the current flowing through the fuel pump 5 can be detected to determine the presence or absence of a problem based on the detected current. Alternatively, the revolution frequency of the fuel pump 5 can also be detected for determination.

When the fuel pump 5 has a problem, (“Yes” in step S14), the power generation of the fuel cell 1 is stopped and, for example, a warning light such as an LED (Light Emitting Diode) is turned on to indicate to the user that the fuel pump 5 has a problem (step S15).

When the fuel pump 5 has no problem (“No” in step S14), whether or not the air pump 6 has a problem is further determined (step S16). Examples of problems associated with the air pump 6 include failure of the motor for driving the pump and clogging of the pump with foreign matter. To detect such a problem, for example, the current flowing through the air pump 6 can be detected to determine the presence or absence of a problem based on the detected current. Alternatively, the revolution frequency of the air pump 6 can also be detected for determination.

When the air pump 6 has a problem, (“Yes” in step S16), the power generation of the fuel cell is stopped, and the presence of the problem in the air pump 6 is indicated to the user (step S17).

When the air pump has no problem (“No” in step S16), the amount of air supplied is increased for a certain period of time to eliminate the possibility that the output power has decreased due to clogging of the oxidant flow channel with water produced in the cathode 22 (step S18). The time for which the amount of air supplied is increased is set to a time that is necessary and sufficient for removing the water accumulated in the cathode 22 from the cathode 22. More specifically, it is set according to the length of the oxidant flow channel formed in the separator 26.

If the set time is too long, the MEA dries, thereby increasing the internal resistance of the fuel cell 1 and decreasing the output. Thus, the set time is desirably a minimum length of time. Also, to increase the amount of air supply, the revolution frequency of the motor for driving the air pump 6 may be increased, or, in the case of a voltage-control type motor, the voltage applied to the motor may be increased.

Next, whether the output power P of the fuel cell 1 is smaller than Prf2 is determined (step S19). If the output power of the fuel cell 1 is equal to or greater than Prf2 (“No” in step S19), this means that the electromotive force of the fuel cell 1 has been restored due to the discharge of the water into the oxidant flow channel, and therefore, step S3 and subsequent steps are repeated.

When the output power of the fuel cell 1 is smaller than Prf2 (“Yes” in step S19), the output power of the fuel cell 1 remains low, although the influence of other factors causing decrease of output than deterioration has been denied, and therefore, a determination that the fuel cell 1 has deteriorated is made. In this case, the power generation of the fuel cell is stopped, and such operations as indicating the deterioration of the fuel cell 1 to the user or urging the user to replace the fuel cell 1 are performed (step S20).

Next, the temperature correction process is described.

FIG. 7 shows an example of the output power-cell temperature characteristic curve (curve 35) of the fuel cell 1. The curve 35 shows the relationship between the output power in the steady state and the cell temperature of the deterioration-free fuel cell in the initial state which was operated to generate power with the amount of fuel supply set to a predetermined value. The set value for the amount of fuel supply is the stoichiometric amount of fuel for providing desired output power.

As shown in the figure, the output power-cell temperature characteristic curve (curve 35) of the fuel cell 1 is an upward curve. That is, as the cell temperature rises, the output power also increases.

As mentioned above, the output power-time characteristic curve of FIG. 6 is the characteristic at a cell temperature T0. Thus, in FIG. 7, the output power at the cell temperature T0 is defined as reference power Prf.

The temperature (cell temperature) of the fuel cell 1 is detected to obtain a detected value T(k) (step S21). The reference power Prf is subtracted from output power Prf(k) on the curve 35 at the detected cell temperature T(k). The value obtained is a correction value Pcrt (step S22).

Then, the output power P is corrected by subtracting the correction value Pcrt therefrom, or each reference value (Ppk0, Prf1, or Prf2) is corrected by adding the correction value Pcrt thereto.

The invention has been described by way of Embodiments, but the invention is not to be construed as being limited thereto. For example, the fuel cell 1 is not limited to a DMFC, and any fuel cell using a power generation device similar to a cell stack can be used for the configuration of the invention. For example, it is also applicable to fuel cells using hydrogen as the fuel, such as solid polymer electrolyte fuel cells or reformed methanol fuel cells. Also, these fuel cells can be controlled by any methods such as the constant voltage control method and the constant current control method.

### INDUSTRIAL APPLICABILITY

The fuel cell system of the invention is widely useful as the power supply system for back-up purpose and the power supply system for various electronic devices such as personal computers.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1 Fuel Cell
8 Control Unit
8a Arithmetic Unit
8b Determination Unit
8c Memory
12 Load
16 Current Sensor
18 Voltage Sensor

1. A method for determining deterioration of a fuel cell, comprising the steps of:
(a) detecting an output power P of a fuel cell;
(b) detecting a peak of the output power P after a startup of the fuel cell;
(c) calculating a decrease rate D of the output power P after the peak of the output power P;
(d) comparing the decrease rate D with a reference decrease rate Dref; and
(e) determining deterioration of the fuel cell based on a comparison result of the step (d).

2. The method for determining deterioration of a fuel cell according to claim 1, further comprising the step (f) of comparing an output power Ppk at the peak with a first reference value Prf1,
wherein a determination that the fuel cell has deteriorated is made when the output power Ppk at the peak is smaller than the first reference value Prf1 and the decrease rate D is greater than the reference decrease rate Dref.

3. The method for determining deterioration of a fuel cell according to claim 1, further comprising the steps of:
(f) comparing an output power Ppk at the peak with a first reference value Prf1, and
(g) after the peak of the output power P, comparing the output power P with a second reference value Prf2 determined from an output power-time characteristic curve of the fuel cell that has not deteriorated, where Prf2<Prf1,
wherein a determination that the fuel cell has deteriorated is made when the output power Ppk at the peak is equal to or greater than the first reference value Prf1, the decrease rate D is greater than the reference decrease rate Dref, and the output power P is smaller than the second reference value Prf2.

4. The method for determining deterioration of a fuel cell according to claim 3, wherein the second reference value Prf2 is a value smaller than an output power Ppoc on the output power-time characteristic curve at a corresponding point of time by 10 to 30%.

5. The method for determining deterioration of a fuel cell according to claim 1, further comprising the steps of:
(f) comparing an output power Ppk at the peak with a first reference value Prf1, and
(h) after the peak of the output power P, comparing the output power P with a third reference value Ppk0 where Ppk0<Prf2,
wherein a determination that the fuel cell has deteriorated is made when the output power Ppk at the peak is smaller than the first reference value Prf1, the decrease rate D is equal to or less than the reference decrease rate Dref, and the output power P is smaller than the third reference value Ppk0.

6. The method for determining deterioration of a fuel cell according to claim 2,
wherein the first reference value Prf1 is a value smaller than an output power Prfp at the peak of the fuel cell that has not deteriorated by 10 to 30%.

7. The method for determining deterioration of a fuel cell according to claim 1,
wherein the detected output power is corrected according to the temperature of the fuel cell.

8. The method for determining deterioration of a fuel cell according to claim 2,
wherein the first reference value Prf1 or the second reference value Prf2 is corrected according to the temperature of the fuel cell.
